(19) United States
(12) Patent Application Publication
(10) Pub. No.: US 2026/0105122 A1
(43) Pub. Date: Apr. 16, 2026

(54) SPATIAL DIMENSIONALITY REDUCTION-BASED SECURE TWO-PARTY VECTOR ELEMENT-WISE MULTIPLICATION METHOD AND RELATED APPARATUS

(71) Applicant: Beihang University, Beijing (CN)

(72) Inventors: Shizhao PENG, Beijing (CN); Tianle TAO, Beijing (CN); Haogang ZHU, Beijing (CN)

(21) Appl. No.: 19/031,634

(22) Filed: Jan. 18, 2025

(30) Foreign Application Priority Data
Oct. 10, 2024 (CN) 202411411711.8

(51) Int. Cl. G06F 17/16

(52) U.S. Cl. CPC G06F 17/16

(57) ABSTRACT

Provided is a spatial dimensionality reduction-based secure two-party vector element-wise multiplication method and a related apparatus. The method includes: preprocessing a private vector of a first participant and a private vector of a second participant obtained to obtain a first participant private matrix and a second participant private matrix; performing secure two-party matrix multiplication computing on the two participant private matrices on the basis of a secure two-party matrix multiplication computing protocol, to obtain a first participant private output matrix and a second participant private output matrix; performing dimensionality reduction conversion processing on the two participant private output matrices respectively, to obtain a first dimensionality-reduced private vector and a second dimensionality-reduced private vector; and aggregating the two dimensionality-reduced private vectors to obtain a secure two-party vector element-wise multiplication result.

### CROSS-REFERENCE TO RELATED APPLICATION

This patent application claims the benefit and priority of Chinese Patent Application No. 202411411711.8 filed with the China National Intellectual Property Administration on Oct. 10, 2024, the disclosure of which is incorporated by reference herein in its entirety as part of the present application.

### TECHNICAL FIELD

The present disclosure relates to the technical field of blockchain security, and in particular to a spatial dimensionality reduction-based secure two-party vector element-wise multiplication method and a related apparatus.

### BACKGROUND

With the development of big data and artificial intelligence, data has become an important resource to promote innovation and economic growth. Privacy-preserving computing is a computing method that ensures data privacy and security for the purpose of protecting the confidentiality of personal information when multiple parties collaborate to process data. Existing privacy-preserving computing technology (PPCT) adopts homomorphic encryption, differential privacy, secret sharing, and other technology. By reducing computing efficiency, computing accuracy, and increasing communication overheads, the PPCT breaks inherent data silo models and drives the circulation of multi-party data, thereby mining value behind data elements.

In training and inference processes of large artificial intelligence (AI) model scenarios, an activation function Sigmoid, an output layer Softmax, and a chain propagation of gradient parameters during backpropagation all involve vector element-wise multiplication operations, which greatly improve the parallelization of privacy-preserving computing. Therefore, on the premise of meeting privacy requirements, it is of great research significance to implement two- or even multi-party vector element-wise multiplication computing. The following summarizes existing relevant technology at home and abroad:

In the prior art, an Obliv-C framework proposed by Zahur and Evans and an ABY framework proposed by Demmler, Schneider, et al. both employ garbled circuit technology, which transforms mathematical operations (addition and multiplication) into Boolean circuits and protects circuit outputs corresponding to respective inputs in combination with encryption technology such as secure shuffling and oblivious transfer.

An MP-SPDZ framework proposed by Keller and the Crypten framework provided by Knott, Venkataraman, et al. use the idea of secret sharing technology to hide secret values. The frameworks randomly decompose each secret value into multiple slices and use a threshold number of nodes to reconstruct and combine the slices when necessary through interactions among various participants, and can resolve a privacy vector element-wise multiplication issue.

Lin, Zhao et al. proposed a SOCI framework by combining an ElGamal homomorphic encryption scheme with Paillier primitive, which can locally encrypt a privacy vector to be computed, then use the encrypted privacy vector to participate in computing, and finally obtain an answer identical to plaintext computing through decryption with a private key, and can resolve a privacy vector element-wise multiplication issue.

However, the above technical solutions have the following advantages and disadvantages:

Both the Obliv-C and ABY frameworks have general-purpose secure two-party computing solutions based on garbled circuits. The garbled circuit technology can support secure two-party vector element-wise multiplication. However, such solutions require the construction of a large number of circuits, resulting in high computational and space complexity and low computational efficiency. Additionally, this technology is essentially aimed at Boolean operations, and involves precision issues in the processing of floating-point numbers, resulting in insufficient practicability.

The MP-SPDZ and Crypten frameworks, based on the idea of secret sharing, divide a numerical value into a number of shares for sharing to hide true values of numerical values of two-party. This ensures that a secret value can only be reconstructed when sufficient participants join together. However, such solutions involve a large number of message exchanges between multiple participants, which will lead to low communication efficiency.

Lin, Zhao et al. proposed the SOCI framework in conjunction with the Paillier primitive, which employs public key encryption and computes a ciphertext and then uses a private key to decrypt a result. Although the framework guarantees the security of computing results, due to the complexity of the ciphertext computing of the framework itself and the reliance thereof on a third-party cloud platform for computing, the framework involves issues of high computing storage and communication overheads and costs, as well as the risk of data leakage once the third-party cloud platform is attacked.

Therefore, how to design a secure two-party vector element-wise multiplication method and a related apparatus that can improve practicality and increase communication efficiency while taking into account higher computing accuracy and lower computing cost requirements and are not prone to data leakage has become a technical problem that needs to be urgently solved in this field.

### Summary

An objective of the present disclosure is to provide a spatial dimensionality reduction-based secure two-party vector element-wise multiplication method and a related apparatus, which can achieve efficient, secure, and reliable privacy-preserving numerical computing, improve practicality, and increase communication efficiency while taking into account higher computing accuracy and lower computing cost requirements, and are not prone to data leakage.

To achieve the above objective, the present disclosure provides the following solutions.

In a first aspect, the present disclosure provides a spatial dimensionality reduction-based secure two-party vector element-wise multiplication method. The spatial dimensionality reduction-based secure two-party vector element-wise multiplication method includes:
obtaining a private vector of a first participant and a private vector of a second participant;
preprocessing the private vector of the first participant and the private vector of the second participant to obtain a first participant private matrix and a second participant private matrix;
performing secure two-party matrix multiplication (S2PM) computing on the first participant private matrix and the second participant private matrix on the basis of a secure two-party matrix multiplication computing protocol, to obtain a first participant private output matrix and a second participant private output matrix, where the secure two-party matrix multiplication computing protocol is a protocol designed based on secure data disguising technology (SDDT); the secure data disguising technology is a technology that decomposes any multi-party operation into a new multi-party addition to disguise an intermediate computing result; a sum of the first participant private output matrix and the second participant private output matrix is a product result of the first participant private matrix and the second participant private matrix;
performing dimensionality reduction conversion processing on the first participant private output matrix and the second participant private output matrix, to obtain a first dimensionality-reduced private vector and a second dimensionality-reduced private vector; and
aggregating the first dimensionality-reduced private vector and the second dimensionality-reduced private vector to obtain a secure two-party vector element-wise multiplication result.

In a second aspect, the present disclosure provides a spatial dimensionality reduction-based secure two-party vector element-wise multiplication apparatus. The spatial dimensionality reduction-based secure two-party vector element-wise multiplication apparatus includes:
a private vector obtaining module, configured to obtain a private vector of a first participant and a private vector of a second participant;
a preprocessing module, configured to preprocess the private vector of the first participant and the private vector of the second participant to obtain a first participant private matrix and a second participant private matrix;
a secure two-party matrix multiplication computing module, configured to perform secure two-party matrix multiplication computing on the first participant private matrix and the second participant private matrix on the basis of a secure two-party matrix multiplication computing protocol, to obtain a first participant private output matrix and a second participant private output matrix, where the secure two-party matrix multiplication computing protocol is a protocol designed based on secure data disguising technology; the secure data disguising technology is a technology that decomposes any multi-party operation into a new multi-party addition to disguise an intermediate computing result; a sum of the first participant private output matrix and the second participant private output matrix is a product result of the first participant private matrix and the second participant private matrix;
a dimensionality reduction conversion processing module, configured to perform dimensionality reduction conversion processing on the first participant private output matrix and the second participant private output matrix, to obtain a first dimensionality-reduced private vector and a second dimensionality-reduced private vector; and
an aggregation module, configured to aggregate the first dimensionality-reduced private vector and the second dimensionality-reduced private vector to obtain a secure two-party vector element-wise multiplication result.

In a third aspect, the present disclosure provides a computer device, including: a memory, a processor, and a computer program stored in the memory and runnable on the processor, where the processor executes the computer program to implement any of the foregoing spatial dimensionality reduction-based secure two-party vector element-wise multiplication method.

In a fourth aspect, the present disclosure provides a computer-readable storage medium having a computer program stored thereon, where when the computer program is executed by a processor, any of the foregoing spatial dimensionality reduction-based secure two-party vector element-wise multiplication method is implemented.

In a fifth aspect, the present disclosure provides a computer program product, including a computer program, where when the computer program is executed by a processor, any of the foregoing spatial dimensionality reduction-based secure two-party vector element-wise multiplication method is implemented.

According to the specific embodiments provided by the present disclosure, the present disclosure discloses the following technical effects:
The present disclosure provides a spatial dimensionality reduction-based secure two-party vector element-wise multiplication method and a related apparatus. Firstly, a private vector of a first participant and a private vector of a second participant are obtained. The private vector of the first participant and the private vector of the second participant are preprocessed to obtain a first participant private matrix and a second participant private matrix. Secondly, secure two-party matrix multiplication computing is performed on the first participant private matrix and the second participant private matrix on the basis of a secure two-party matrix multiplication computing protocol, to obtain a first participant private output matrix and a second participant private output matrix. Then, dimensionality reduction conversion processing is performed on the first participant private output matrix and the second participant private output matrix, to obtain a first dimensionality-reduced private vector and a second dimensionality-reduced private vector. Finally, the first dimensionality-reduced private vector and the second dimensionality-reduced private vector are aggregated to obtain a secure two-party vector element-wise multiplication result. The present disclosure designs a secure two-party matrix multiplication computing protocol based on secure data disguising technology. The protocol does not need to introduce any secret key, and by virtue of its own characteristic of disguising and encrypting data based on real number field, ensures the security of “one-time-pad” while also taking into account higher computing accuracy and lower computing cost requirements. Furthermore, through dimensionality reduction conversion processing, the present disclosure solves the problem of low communication efficiency of secret sharing technology due to a need for a large amount of information exchange. Additionally, the present disclosure does not need to rely on a third-party cloud platform, and can solve a risk of data leakage in homomorphic encryption technology caused by attacks on the third-party cloud platform.

### BRIEF DESCRIPTION OF THE DRAWINGS

To illustrate the technical solutions in the embodiments of the present disclosure or conventional art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a flowchart of a spatial dimensionality reduction-based secure two-party vector element-wise multiplication method according to an embodiment of the present disclosure;

FIG. 2 is a schematic diagram of a secure two-party vector element-wise multiplication problem according to an embodiment of the present disclosure;

FIG. 3 is a schematic diagram of secure data disguising technology according to an embodiment of the present disclosure;

FIG. 4 is a schematic diagram of a secure two-party matrix multiplication computing problem according to an embodiment of the present disclosure;

FIG. 5 is a flowchart of a secure two-party matrix multiplication computing protocol according to an embodiment of the present disclosure;

FIG. 6 is a flowchart of a secure two-party vector element-wise multiplication protocol according to an embodiment of the present disclosure;

FIG. 7 is a schematic diagram of a secure multi-party vector element-wise multiplication problem according to an embodiment of the present disclosure;

FIG. 8 is a flowchart of a secure multi-party vector element-wise multiplication protocol according to an embodiment of the present disclosure;

FIG. 9 is a schematic diagram of functional modules of a spatial dimensionality reduction-based secure two-party vector element-wise multiplication apparatus according to an embodiment of the present disclosure;

FIG. 10 is a diagram of an implementation apparatus of a secure two-party vector element-wise multiplication algorithm applied to a distributed computing node according to an embodiment of the present disclosure;

FIG. 11 is a schematic structural diagram of a computer device according to an embodiment of the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. All other embodiments obtained by those of ordinary skill in the art based on the embodiments of the present disclosure without creative efforts shall fall within the scope of protection of the present disclosure.

To make the above objective, features and advantages of the present disclosure clearer and more comprehensible, the present disclosure is further described in detail below with reference to the accompanying drawings and specific implementations.

Terminology explanation:
Semi-honest model: the semi-honest model, Semi-Honest Adversaries Security, is a specific protocol that assumes that all participants in computing will honestly participate in privacy-preserving computing and strictly perform each step of process in accordance with a protocol. However, there is a risk that some corrupt participants will attempt to infer the privacy of other participants through intermediate or final results of a protocol execution process.
Secure Two-Party Matrix Multiplication Computing Protocol: the Secure Two-Party Matrix Multiplication Protocol, as the name implies, assumes that there are two participants P1 and P2 that do not trust each other. The two participants hold secret input matrices x and y, respectively, and jointly execute a two-party multiplication protocol f(x,y)=Output(v₁,v₂)=x·y. Finally, the two participants obtain corresponding outputs v₁ and v₂, respectively, and the outputs satisfies v₁+v₂=x·y. In the entire computing process, each participant node only knows input and output data involved in its own computing process and cannot obtain any intermediate computing results of the other participant.
Secure Two-Party Vector Element-Wise Multiplication Protocol: the Secure Two-party Vector Element-Wise Multiplication (S2PVEM) Protocol, as the name implies, assumes that there are two participants P1 and P2 that do not trust each other. The two participants hold secret input vectors x and y, respectively, and jointly execute a secure two-party vector element-wise multiplication protocol f(x,y)=Output(v₁,v₂)=x⊚y. Finally, the two participants obtain corresponding outputs v₁ and v₂, respectively, and the outputs satisfy v₁+v₂=x⊚y. In the entire computing process, each participant node only knows input and output data involved in its own computing process and cannot obtain any intermediate computing results of the other participant.
Secure Multi-Party Vector Element-Wise Multiplication Protocol: the Secure Multi-Party Vector Element-Wise Multiplication (SNPVEM) Protocol, as the name implies, assumes that there are a total of N participants P₁, P₂, . . . , P_{N} that do not trust each other. The N participants hold secret input vectors α₁, α₂, . . . , α_{N}∈R^{m}, respectively, and jointly execute a secure multi-party vector element-wise multiplication protocol f(α₁, α₂, . . . , α_{N})=α₁⊚α₂⊚ . . . α_{N}. Finally, the N participants obtain corresponding outputs W₁, W₂, . . . , W_{N}, respectively, and the outputs satisfy W₁+W₂+ . . . +W_{N}=α₁⊚α₂⊚ . . . ⊚α_{N}. In the entire computing process, each participant node only knows input and output data involved in its own computing process and cannot obtain any intermediate computing results of other participants.
Secure Data Disguising Technology: the secure data disguising technology is a data protection means used to protect intermediate results of multi-party secure computing. By properly constructing a computing protocol, computing results are randomly decomposed, so that outputs of multiple parties together constitute a real target computing result in a linear combination manner, ultimately achieving a one-time-pad data privacy protection effect.
Privacy-preserving computing technology: the privacy-preserving computing technology specifically refers to a series of information security technology that breaks down data silos, coordinates multi-party computing, and ultimately achieves complex computing and modeling analysis on multi-source data without exposing the privacy of private data of participants, thereby ensuring that data elements are “available but invisible” during circulation and integration processes.

The present disclosure mainly focuses on the problem of secure two-party vector element-wise multiplication to achieve efficient, secure, and reliable privacy-preserving numerical computing. Therefore, based on the above objective, the technical problems to be solved by the present disclosure are as follows:
1) Existing solutions to the problem of secure two-party vector element-wise multiplication mostly employ computing frameworks developed based on traditional basic cryptographic primitives such as homomorphic encryption, secret sharing, and garbled circuits. These methods rely on ciphertext space computing with extremely high time and space complexities, which in turn leads to low practicality and insufficient efficiency.
2) The existing solutions to the problem of secure two-party vector element-wise multiplication employ large prime number encryption, which increases the number of ciphertext bits in a computational space or introduces differential noise, causing the loss of model training parameter precision, directly leading to insufficient numerical computing accuracy, and affecting the reliability of computing results.
3) Existing application scenarios involving secure two-party vector element-wise multiplication schemes mostly rely on outsourced cloud service systems for implementation. However, the low credibility of third-party cloud service computing platforms or attacks by malicious nodes may cause the leakage of intermediate computing results or critical key information, and further lead to security risks of privacy leakage of original data parties.

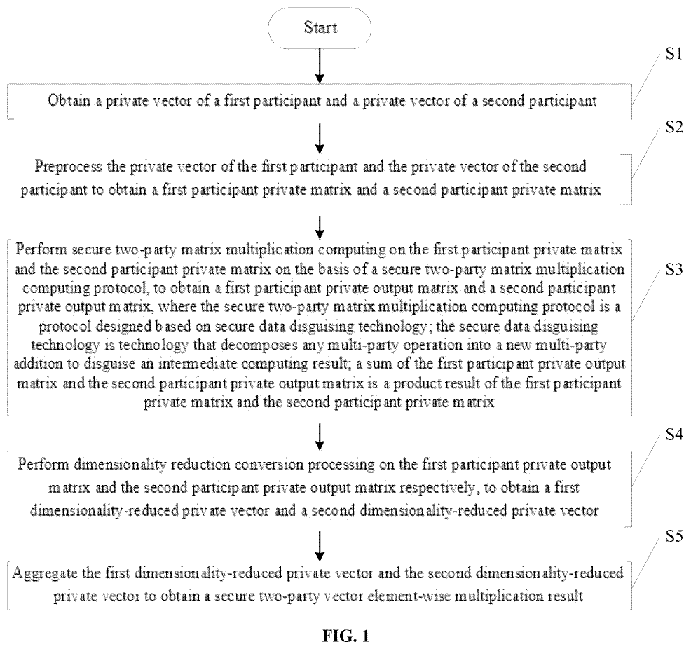

In an exemplary embodiment, as shown in FIG. 1, a spatial dimensionality reduction-based secure two-party vector element-wise multiplication is provided. The method includes steps S1 to S5.

Step S1: a private vector of a first participant and a private vector of a second participant are obtained.

Step S2: the private vector of the first participant and the private vector of the second participant are preprocessed to obtain a first participant private matrix and a second participant private matrix.

Step S3: secure two-party matrix multiplication computing is performed on the first participant private matrix and the second participant private matrix on the basis of a secure two-party matrix multiplication computing protocol, to obtain a first participant private output matrix and a second participant private output matrix. The secure two-party matrix multiplication computing protocol is a protocol designed based on secure data disguising technology. The secure data disguising technology is a technology that decomposes any multi-party operation into a new multi-party addition to disguise an intermediate computing result. A sum of the first participant private output matrix and the second participant private output matrix is a product result of the first participant private matrix and the second participant private matrix.

Step S4: dimensionality reduction conversion processing is performed on the first participant private output matrix and the second participant private output matrix, to obtain a first dimensionality-reduced private vector and a second dimensionality-reduced private vector.

Step S5: the first dimensionality-reduced private vector and the second dimensionality-reduced private vector are aggregated to obtain a secure two-party vector element-wise multiplication result.

By implementing the above step S1 to step S5, the present disclosure designs a secure two-party matrix multiplication computing (S2PM) protocol based on secure data disguising technology (SDDT). The protocol does not need to introduce any secret key, and by virtue of its own characteristic of disguising and encrypting data based on real number field, ensures the security of “one-time-pad” while also taking into account higher computing accuracy and lower computing cost requirements. Furthermore, through dimensionality reduction conversion processing, the present disclosure solves the problem of low communication efficiency of secret sharing technology due to a need for a large amount of information exchange. Additionally, the present disclosure does not need to rely on a third-party cloud platform, and can solve a risk of data leakage in homomorphic encryption technology caused by attacks on the third-party cloud platform.

A secure two-party vector element-wise multiplication problem is defined as follows:

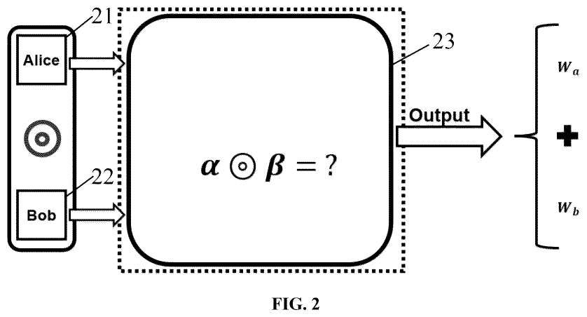

It is known that there are two computing parties, namely a first computing party 21, also called Alice and a second computing party 22, also called Bob, which are independent of each other and do not trust each other, Alice holds an n-dimensional private vector α=(α₁, α₂, . . . , αₙ)^{T}, and Bob holds an n-dimensional private vector β=(β₁, β₂, . . . , βₙ)^{T}. The two participants intend to jointly execute a secure two-party vector element-wise multiplication protocol 23 to achieve f_{S2PVEM}(α,β)=α⊚β=Wₐ+W_{b}. Finally, each computing participant node obtains a respective corresponding output, Wₐ and W_{b}, and sends the output to a computing requester for aggregation to obtain a desired scalar product result of the two parties. In the computing process, each participant node can only know its own input and output information, and cannot obtain intermediate computing results and held data information of the other participant. A formal depiction of the problem is shown in FIG. 2.

Secure data disguising technology is as follows.

For most multi-party computations, a process of achieving secure computation usually involves multiple steps of interaction, which results in a problem how to ensure the security of intermediate results. For example, when a two-party matrix product A×B is used as an intermediate result of computing, no matter which of the participant node Alice or the participant node Bob obtains a final matrix A×B result, the participant node may infer data of the other participant. Therefore, in a privacy-preserving computing process, not only the security of initial input data needs to be guaranteed, but also the security of intermediate computing results needs to be guaranteed.

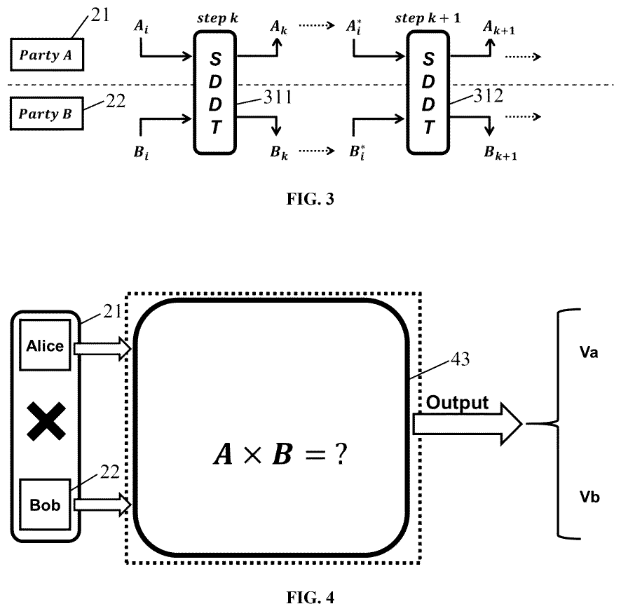

To solve this problem, the present disclosure proposes secure data disguising encryption technology, which is to decompose any multi-party operation into a new multi-party addition to disguise intermediate computing results. To facilitating illustrating the principle of the technology, a two-party operation type is used herein as an example, and the principle thereof is shown in FIG. 3. It is assumed that Sₖ=Fₖ(Aᵢ,Bᵢ), where Fₖ is a target computing function of the k-th step, data Aᵢ is private input data of the k-th step 311 of the party Alice 21, also called party A, and data B; is private input data of the k-th step 311 of the party Bob 22, also called party B. When the k-th step 311 of a multi-party secure computation protocol is performed, an intermediate result Sₖ will strictly follow the following constraints: Alice 21 only know its own computing result Aₖ, and Bob 22 only know its result Bₖ, and Aₖ+Bₖ=Sₖ. Formula [Aᵢ:Bᵢ]→[Aₖ:Bₖ|Aₖ+Bₖ=Fₖ(Aᵢ,Bᵢ)] represents a transmission process of the intermediate value. In the whole process, Alice 21 and Bob 22 are not allowed to exchange data information with each other, including computing result Aₖ and Bₖ decomposed from the intermediate computing result. Similarly, for the (k+1)-th step 312, an input

$${A}_{i}^{*} = {A}_{k} and {B}_{i}^{*} = {B}_{k} ;$$

thereof consists of transmission of the outputs Aₖ and Bₖ of Alice 21 and Bob 22 in the k-th step 311, and

$${A}_{i}^{*} and {B}_{i}^{*}$$

an output Aₖ₊₁ and Bₖ₊₁ thereof satisfies

$${S}_{k + 1} = {F}_{k + 1} ( {A}_{i}^{*} , {B}_{i}^{*} ) = {A}_{k + 1} + {B}_{k + 1} ,$$

where Alice 21 only knows its own computing result Aₖ₊₁ and Bob 22 only knows its result Bₖ₊₁. Therefore, provided that the intermediate value is decomposed into two random data items stored separately on the two computing participants at each step of the computing, it can be guaranteed that no participant can reverse the original data item from that disguised encrypted data, thereby making the entire privacy-preserving computing process more secure.

A secure two-party matrix multiplication computation protocol problem is defined as follows:

It is known that there are two computing parties, namely a first computing party 21, also called Alice and a second computing party 22, also called Bob, which are independent of each other and do not trust each other. Alice holds an n×s-dimensional private data matrix A stored only on its own computing node, and Bob holds an s×m-dimensional private data matrix B. The two participants intend to jointly execute a secure matrix multiplication protocol 43 to achieve f(A,B)=AB=Vₐ+V_{b}, and finally each computing participant node obtains its respective corresponding n×m-dimensional output matrix, Vₐ, and sends the output matrix to a computing requester for aggregation to obtain a two-party matrix product result desired thereby. In the computing process, each participant node can only know its own input and output information, and cannot obtain intermediate computing results and held data information of the other participant. A formal depiction of the problem is shown in FIG. 4.

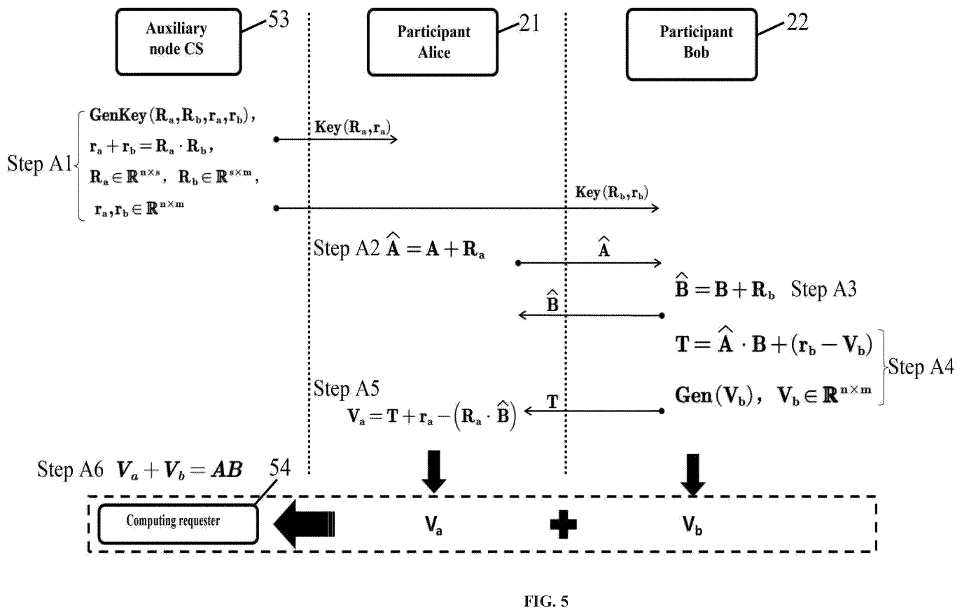

As shown in FIG. 5, a process of the secure two-party matrix multiplication computing protocol is as follows:
Step A1: An auxiliary computing node 53, also known as a commodity server (CS) node, generates two random matrix pairs with specific forms of an n×s-dimensional random matrix Rₐ, an s×m-dimensional random matrix R_{b}, and two n×m-dimensional random matrices rₐ, r_{b}. These random matrices must strictly satisfy the following constraint rₐ+r_{b}=Rₐ·R_{b} thereamong. The auxiliary node CS 53 then sends the random matrix pair (Rₐ,rₐ) to the participant Alice computing node, and sends the random matrix pair (R_{b},r_{b}) to the participant Bob computing node.
Step A2: After receiving the corresponding random matrix pair (Rₐ,rₐ), the participant Alice21 computes Â=A+Rₐ within its node, and sends matrix Â to the participant node Bob 22.
Step A3: After receiving the corresponding random matrix pair (R_{b},r_{b}), the participant Bob 22 computes \hat{B}=B+R_{b} within its node, and sends matrix \hat{B} to the participant node Alice 21.
Step A4: After receiving the matrix Â sent from the participant Alicenode, the participant Bob node secretly generates a random matrix V_{b}∈R^{n×m} within its node, and secretly computes a matrix T=Â·B+(r_{b}−V_{b}) locally, and sends the matrix T to the participant Alice node.
Step A5: After receiving the matrix T, the participant Alice node performs secret computing locally to obtain a matrix Vₐ=T+rₐ−(Rₐ·\hat{B}).
Step A6: The participants Alice node and Bob node send final disguised decomposed results Vₐ and V_{b} corresponding thereto, respectively, to the two-party matrix multiplication computing requester 54, which will aggregate the results to obtain a final product AB=Vₐ+V_{b}.

It is easy to verify that:

$${V}_{a} + {V}_{b} = [ ( \hat{A} \cdot B + ( {r}_{b} - {V}_{b} ) ) + {r}_{a} - ( {R}_{a} \cdot \hat{B} ) ] + {V}_{b} = [ \text{} ( A \cdot B - {V}_{b} ) + {r}_{a} + {r}_{b} - {R}_{a} \cdot {R}_{b} ) ] + {V}_{b} = A \cdot B .$$

The secure two-party vector element-wise multiplication protocol is as follows.

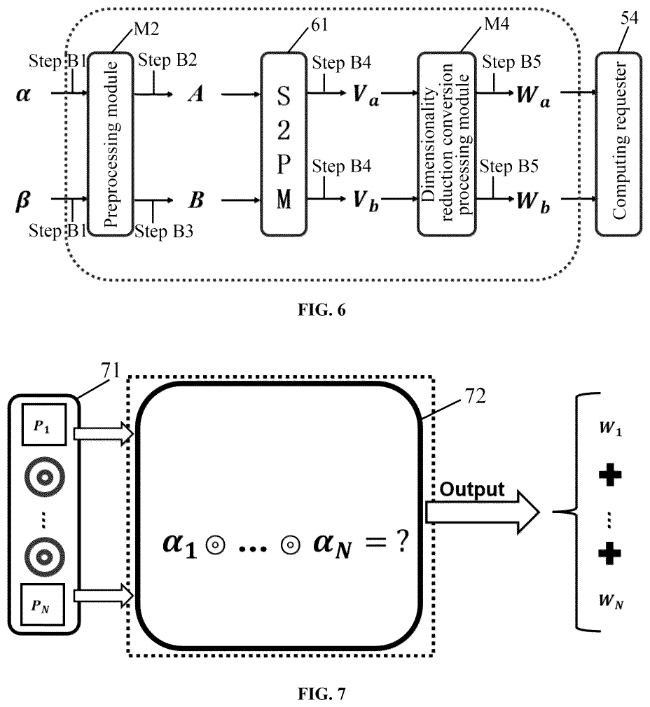

The secure two-party vector element-wise multiplication problem usually occurs in application scenarios such as logistic regression, privacy of parallel computing of activation functions of multi-layer perceptrons, and privacy-preserving matrix element-wise multiplication, and has broad research value. Therefore, without loss of generality, it is assumed that an initial input of the compute participating node Alice in the protocol is an m-dimensional private vector α=(α₁, α₂, . . . , αₘ), and an initial input of the compute participating node Bob is an m-dimensional private vector β=(β₁, β₂, . . . , βₘ). On this basis, an efficient parallelized secure two-party vector element-wise multiplication protocol is proposed, as shown in FIG. 6.

Specifically, a process of the secure two-party vector element-wise multiplication protocol is as follows.
Step B1: The participant Alice node and the participant Bob node jointly negotiate a positive integer n≥2, and decompose each element of the private vector held thereby, respectively, into n random positive numbers that are not equal to each other. The participant Alice node decomposes αᵢ(1≤i≤m) and then combines corresponding decomposed results into an n-dimensional private vector

$${θ}_{a}^{〈 i 〉} = ( {θ}_{a 1}^{〈 i 〉} , {θ}_{a 2}^{〈 i 〉} , … , {θ}_{an}^{〈 i 〉} ) ∈ {R}^{n} ,$$

and the participant Bob node decomposes βᵢ(1≤i≤m) and then combines corresponding decomposed results into an n-dimensional private vector

$${θ}_{b}^{〈 i 〉} = ( {θ}_{b 1}^{〈 i 〉} , {θ}_{b 2}^{〈 i 〉} , … , {θ}_{bn}^{〈 i 〉} ) ∈ {R}^{n} .$$

Step B2: The participant Alice node transforms the n-dimensional private vector

$${θ}_{a}^{〈 i 〉} = ( 1 \leq i \leq m )$$

into a n²-dimensional private vector

$${θ}_{a}^{〈 i 〉 *} = ∈ {R}^{{n}^{2}} ,$$

specifically, by concatenating n vectors

$${θ}_{a}^{〈 i 〉}$$

together in sequence to obtain a new vector

$${θ}_{a}^{〈 i 〉 *} .$$

A private matrix A∈R^{m×n}^{²} is then formed from the vector group

$$\{ {θ}_{a}^{〈 1 〉 *} , {θ}_{a}^{〈 2 〉 *} , … , {θ}_{a}^{〈 m 〉 *} \}$$

correspondingly in rows from top to bottom.
Step B3: The participant Bob node transforms each private vector

$${θ}_{b}^{〈 i 〉} ( 1 \leq i \leq m )$$

into a private variable

$${θ}_{b}^{〈 i 〉 *} ∈ {R}^{{n}^{2}} .$$

First, n elements in the private vector

$${θ}_{b}^{〈 i 〉}$$

are fully permutated and each permutation is transformed into a vector, and then s=n! random permuted vectors are obtained in total, which process is expressed as

$$\begin{matrix}{θ}_{b}^{< i >} \{ {θ}_{bj}^{< i >} = perms ( {θ}_{b 1}^{< i >} , {θ}_{b 2}^{< i >} , … , {θ}_{bn}^{< i >} ) \vert j = \\ 1 , 2 , … , s ) \} ,\end{matrix}$$

where perms is a function to perform a full permutation operation on m elements

$$( {θ}_{b 1}^{< i >} , {θ}_{b 2}^{< i >} , … , {θ}_{bn}^{< i >} ) .$$

Then, n vectors

$${θ}_{b 2}^{< i >} ( j ∈ \{ 1 , 2 , … , s \} )$$

are randomly selected from

$$\{ {θ}_{b 1}^{< i >} \sim {θ}_{bs}^{< i >} \} ,$$

to form in the form of row vectors together a private matrix

$${T}_{b}^{< i >} ∈ {R}^{n \times n} .$$

Then, the matrix

$${T}_{b}^{< i >}$$

is subjected to dimensionality reduction to form a vector

$${θ}_{b}^{< i > *} .$$

Specifically, each column vector of the matrix

$${T}_{b}^{< i >}$$

is concatenated together to transform from a matrix space to a vector space. Finally, the vectors

$${θ}_{b}^{< 1 > *} , {θ}_{b}^{< 2 > *} , … , {θ}_{b}^{< m > *}$$

are sequentially used as columns of a matrix to constitute a private matrix B∈Rⁿ^{²}^{×m} together.

Step B4: The participant Alice node and the participant Bob node input, based on the secure two-party matrix multiplication computing (S2PM) protocol 61, their own private data A∈R^{m×n}^{²} and B∈Rⁿ^{²}^{×m}, respectively, to perform a round of secure two-party matrix multiplication f_{S2PM}(A,B)=A×B. After execution of computing of the S2PM protocol 61 is completed, the round of computing f_{S2PM}(A,B) is decomposed into two results Vₐ, V_{b}∈R^{m×m} on the basis of the security data disguising technology. The two results are respectively sent to the participant Alice node and the participant Bob node as private outputs thereof, and these two private output matrices satisfy a relationship f_{S2PM}(A,B)=A×B=Vₐ+V_{b}.

Step B5: After obtaining the private matrices Vₐ, V_{b}∈R^{m×m} respectively, the participant Alice node and the participant Bob node each locally take out and vectorize main diagonal n elements of the matrices to obtain private vectors Wₐ=m2v(diag(Vₐ)) and W_{b}=m2v(diag(V_{b})) respectively, where Wₐ is a first dimensionality-reduced private vector (Alice dimensionality-reduced private vector), W_{b} is a second dimensionality-reduced private vector (Bob dimensionality-reduced private vector), m2v is a function to convert an element of a diagonal matrix into a corresponding vector element-wise, and diag is a function to extract an diagonal element of an arbitrary matrix to form the diagonal matrix. Then, Wₐ and W_{b} and sent to the computing requester, and aggregated by the computing requester 54 to obtain f_{S2PVEM}(α,β)=Wₐ+W_{b}=α⊚β.

It is easy to verify that:

$$\begin{matrix}{W}_{a} + {W}_{b} = m 2 v ( diag ( {V}_{a} ) ) + m 2 v ( diag ( {V}_{b} ) ) = \\ M 2 v ( diag ( {V}_{a} + {V}_{b} ) ) = m 2 v ( diag ( A \times B ) ) = ( {\sum }_{i = 1}^{n} {θ}_{a 1}^{< i >} \times {\sum }_{i = 1}^{n} {θ}_{b 1}^{< i >} , {\sum }_{i = 1}^{n} {θ}_{a 2}^{< i >} \times \\ {\sum }_{i = 1}^{n} {θ}_{b 2}^{< i >} , … , {\sum }_{i = 1}^{n} {θ}_{am}^{< i >} \times {\sum }_{i = 1}^{n} {θ}_{bm}^{< i >} ) = ( {α}_{1} \times {β}_{1} , {α}_{2} \times {β}_{2} , … , {α}_{m} \times {β}_{m} ) = α ⊙ β .\end{matrix}$$

In an exemplary embodiment, step S2 specifically includes:
S21: determining a decomposition positive integer, the decomposition positive integer is greater than or equal to 2;
S22: decomposing each element of the private vector of the first participant according to the decomposition positive integer, to obtain a number of first decomposed private vectors;
S23: decomposing each element of the private vector of the second participant according to the decomposition positive integer to obtain a number of second decomposed private vectors;
S24: transforming and sorting a number of first decomposed private vectors to obtain the first participant private matrix;
S25: transforming and sorting a number of second decomposed private vectors to obtain the second participant private matrix.

In an exemplary embodiment, step S3 specifically includes:
S31: generating two random matrix pairs on the basis of the auxiliary computing node; the two random matrix pairs include a random matrix pair (Rₐ,rₐ) and a random matrix pair (R_{b},r_{b}); the dimensionality of the random matrix Rₐ is n×s, the dimensionality of the random matrix R_{b} is s×m, and the dimensionalities of the random matrix rₐ and the random matrix r_{b} are n×m; rₐ+r_{b}=Rₐ·R_{b};
S32: sending the random matrix pair (Rₐ,rₐ) to the first participant;
S33: sending the random matrix pair (R_{b},r_{b}) to the second participant;
S34: after receiving the random matrix pair (Rₐ,rₐ), the first participant computes a sum of the first participant private matrix and the random matrix Rₐ to obtain a first matrix sum, and sends the first matrix sum to the second participant;
S35: after receiving the random matrix pair (R_{b},r_{b}), the second participant computes a sum of the second participant private matrix and the random matrix R_{b} to obtain a second matrix sum, and sends the second matrix sum to the first participant;
S36: after receiving the first matrix sum, the second participant generates the second participant private output matrix;
S37: computing and obtaining a disguising matrix according to the second participant private output matrix; and sending the disguising matrix to the first participant; where a computing formula for the disguising matrix is T=Â·B+(r_{b}−V_{b}), where T is the disguising matrix, Â is the first matrix sum, B is the second participant private matrix, and V_{b} is the second participant private output matrix, which is a random matrix secretly generated internally;
S38: after receiving the disguising matrix, the first participant computes and obtains the first participant private output matrix; where a computing formula for the first participant private output matrix is Vₐ=T+rₐ−(Rₐ·\hat{B}), where Vₐ is the first participant private output matrix, and \hat{B} is the second matrix sum.

The present disclosure designs a secure two-party matrix multiplication computing protocol based on secure data disguising technology. The protocol does not need to introduce any secret key, and by virtue of its own characteristic of disguising and encrypting data based on real number field, ensures the security of “one-time-pad” while also taking into account higher computing accuracy and lower computing cost requirements.

The present disclosure proposes a secure two-party vector element-wise multiplication protocol, which transforms a numerical value to a two-dimensional matrix space through scaling, and then compresses the two-dimensional matrix space into a one-dimensional vector space through spatial dimensionality reduction, thereby implementing an operation of transforming vector element-wise multiplication into matrix multiplication. According to the distributive law and associative law of numerical multiplication, it is ensured that only one round of the secure two-party matrix multiplication protocol needs to be called to obtain a final result through parallel computing, thus solving the problem of low communication efficiency of secret sharing technology due to a need for a large amount of information exchange.

The secure two-party vector element-wise multiplication protocol and the secure multi-party element-wise multiplication protocol proposed in the present disclosure do not need to rely on a third-party cloud platform, and can solve a risk of data leakage in homomorphic encryption technology caused by attacks on the third-party cloud platform.

It should be noted that an alternative for the secure two-party vector element-wise multiplication is as follows.

Protocol idea includes steps 1 and 2.

Step 1: numerical multiplication in the secure two-party numerical multiplication protocol is converted to a vector scalar product. If there is another secure two-party numerical multiplication protocol which converts numerical multiplication a×b to matrix multiplication A×B, then based on the idea of a preprocessing module in the secure two-party vector element-wise multiplication protocol, the matrices A and B in another secure two-party numerical multiplication protocol may be compressed into two vectors, thus converting the numerical multiplication a×b to a vector scalar product form.

Step 2: the vector element-wise multiplication in the secure two-party vector element-wise multiplication protocol is converted to matrix multiplication. Based on the method of converting numerical multiplication into a vector scalar product in the secure two-party numerical multiplication protocol in step 1, a vector may be converted into a matrix composed of a number of row vectors or column vectors, to convert vector element-wise multiplication to matrix multiplication, and then secure two-party vector element-wise multiplication may be implemented using the secure two-party matrix multiplication protocol.

In terms of scalability, most of existing solutions perform well in secure two-party vector element-wise multiplication, but many problems will arise during expansion to multi-party vector element-wise multiplication. The garbled circuit scheme adopted by the Obliv-C and ABY frameworks will lead to large circuit scale and very high computation and communication overheads when encountering large-scale data computing. The secret sharing scheme will produce more information exchange when processing multi-party element-wise multiplication, and the communication efficiency is low. Because homomorphic encryption itself employs encryption technology, computational costs are huge when multi-party multiplication is involved.

In another exemplary embodiment of the present disclosure, a secure multi-party vector element-wise multiplication protocol problem is defined as follows.

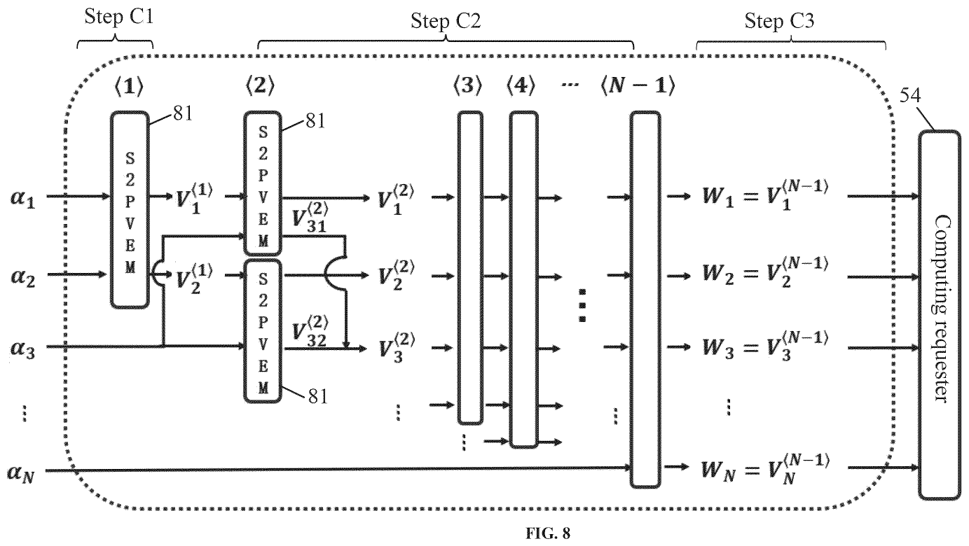

It is known that there are N computing participants 71 P₁, P₂, . . . , P_{N} that are independent of each other and do not trust each other, each holding a private vector data stored only in its own computing node, which are α₁, α₂, . . . , α_{N}∈R^{m}, respectively. The N participants 71 jointly execute a multi-party vector element-wise multiplication protocol 72 f(α₁, α₂, . . . , α_{N})=α₁⊚α₂⊚ . . . ⊚α_{N}=W₁+W₂+ . . . +W_{N}, and finally each computing participant node obtains a respective corresponding output W₁, W₂, . . . , W_{N}, and sends the output to a computing requester to obtain a multi-party vector element-wise multiplication computing result desired thereby. In the computing process, each participant node can only obtain its own input and output information during the computing process, and cannot obtain intermediate computing results and held private data information of the other participants. A formal depiction of the problem is shown in FIG. 7.

As shown in FIG. 8, a process of the secure multi-party vector element-wise multiplication protocol is as follows.

Step C1: A participant P₁ node and a participant P₂ node respectively input their own private vector α₁∈R^{m} and α₂∈R^{m} on the basis of the secure two-party multiplication protocol S2PVEM 81, conduct [symbol] 1 [symbol] -st layer secure two-party vector element-wise multiplication protocol computation f_{S2PVEM}

$$( {α}_{1} , {α}_{2} ) = {α}_{1} ⊙ {α}_{2} = {V}_{1}^{< 1 >} + {V}_{2}^{< 1 >} ,$$

and respectively obtain results

$${V}_{1}^{< 1 >} , {V}_{2}^{< 1 >} ∈ {R}^{m} .$$

Step C2: The following process is performed N−2 times circularly. For the i(1≤i≤N−2)-th cycle, based on the secure two-party vector element-wise multiplication protocol S2PVEM 81, i+1 rounds of the S2PVEM 81 protocol are executed for i+2 computing participants in layer <i+1> (<i> in FIG. 8 shows the i-th layer), where in the j(1≤j≤i+1)-th round of secure two-party vector element-wise multiplication, a participant Pⱼ node and a participant Pᵢ₊₂ node input their own private data

$${V}_{j}^{< i >} ∈ {R}^{m} and {α}_{i + 2} ∈ {R}^{m}$$

to
compute

$${f}_{S 2 PVEM} ( {V}_{j}^{< i >} , {α}_{i + 2} ) = {V}_{j}^{< i >} ⊙ {α}_{i + 2} = {V}_{j}^{< i + 1 >} + {V}_{( i + 2 ) j}^{< i + 1 >}$$

to obtain results

$$\begin{matrix}{V}_{j}^{< i + 1 >} , \\ {V}_{( i + 2 ) j}^{< i + 1 >} ∈ {R}^{m}\end{matrix}$$

respectively. Then the participant Pᵢ₊₂ node locally computes

$${V}_{i + 2}^{〈 i + 1 〉} = {\sum }_{j = 1}^{i + 1} {V}_{( i + 2 ) j}^{〈 i + 1 〉} .$$

Step C3: After all the participant Pᵢ(1≤i≤N) nodes obtain private vectors

$${V}_{i}^{〈 N - 1 〉} ∈ {R}^{m} , {W}_{i} = {V}_{i}^{〈 N - 1 〉}$$

is obtained. Then Wᵢ are sent to a computing requester 54, and then aggregated by the computing requester 54 to obtain

$$f ( {α}_{1} , {α}_{2} , … , {α}_{N} ) = {\sum }_{i = 1}^{N} {W}_{i} = {α}_{1} {α}_{2} … {α}_{N} .$$

It is easy to verify that:

$${\sum }_{i = 1}^{N} {W}_{i} = ( ( ( {α}_{1} {α}_{2} {α}_{3} ) … {α}_{N} ) = {α}_{1} {α}_{2} … {α}_{N} .$$

The present disclosure performs expansion based on the secure two-party vector element-wise multiplication protocol (S2PVEM) and proposes a secure multi-party vector element-wise multiplication protocol (SNPVEM), which also utilizes the idea of scaling and spatial dimensionality reduction to transform vector element-wise multiplication into matrix multiplication, and calls

$$\frac{N \times ( N - 1 )}{2}$$

rounds of the secure two-party multiplication protocol (S2PVEM) for computing to obtain a final result, solving the problem of poor scalability of garbled circuits, secret sharing, and homomorphic encryption technology.

In summary, the present disclosure implements a secure two-party matrix multiplication computing protocol (S2PM) based on secure data disguising technology. The protocol is lightweight, low-overhead, and computationally efficient. The present disclosure solves the problems of high communication overheads, high computational complexity, and low availability caused by mixed calls of technology such as homomorphic encryption, secret sharing, oblivious transmission, and garbled circuits in existing cryptographic schemes.

The present disclosure proposes for the first time a privacy protection solution to the problem of secure two-party vector element-wise multiplication, key technical points of which are to introduce a scaling method that transforms a numerical space into a matrix space and then reduces the dimensionality of the space to convert into a vector space. In the scaling method, elements in a vector are decomposed into vectors based on a positive integer n negotiated together by two participants, then decomposed vectors are transformed into a matrix, and then the dimensionality of the matrix is reduced to form a vector, thereby transforming vector element-wise multiplication into matrix multiplication. This transformation process involves the privacy of original data of participant nodes and is an important step to ensure security.

The present disclosure performs computing according to the secure two-party matrix multiplication protocol S2PM implemented based on the secure data disguising technology, and generates a final answer through a local solving module. These two steps ensure the security of the computing process and the non-disclosure of a private answer of each participant node when the answer is obtained from a main diagonal.

The present disclosure further provides an application scenario, which applies the spatial dimensionality reduction-based secure two-party vector element-wise multiplication method described above. Specifically, the spatial dimensionality reduction-based secure two-party vector element-wise multiplication method according to this embodiment can be applied to a semi-honest scenario. The semi-honest scenario includes a private vector obtaining link, a preprocessing link, a secure two-party matrix multiplication computing link, a dimensionality reduction and conversion link, and an aggregation link; the secure two-party matrix multiplication computing link especially includes: preprocessing a private vector of a first participant and a private vector of a second participant obtained to obtain a first participant private matrix and a second participant private matrix, performing secure two-party matrix multiplication computing on the first participant private matrix and the second participant private matrix on the basis of a secure two-party matrix multiplication computing protocol, to obtain a first participant private output matrix and a second participant private output matrix, performing dimensionality reduction conversion processing on the first participant private output matrix and the second participant private output matrix respectively, to obtain a first dimensionality-reduced private vector and a second dimensionality-reduced private vector, and aggregating the first dimensionality-reduced private vector and the second dimensionality-reduced private vector to obtain a secure two-party vector element-wise multiplication result.

Based on the same inventive concept, an embodiment of the present disclosure further provides a spatial dimensionality reduction-based secure two-party vector element-wise multiplication apparatus for implementing the foregoing spatial dimensionality reduction-based secure two-party vector element-wise multiplication method. An implementation solution to the problem provided by the apparatus is similar to the implementation solution described in the method above. Therefore, for specific definitions in one or more embodiments of the spatial dimensionality reduction-based secure two-party vector element-wise multiplication apparatus provided below, reference may be made to the above definitions on the spatial dimensionality reduction-based secure two-party vector element-wise multiplication method, which will not be repeated herein.

In an exemplary embodiment, as shown in FIG. 9, a spatial dimensionality reduction-based secure two-party vector element-wise multiplication apparatus is provided. The spatial dimensionality reduction-based secure two-party vector element-wise multiplication apparatus includes:
a private vector obtaining module M1, configured to obtain a private vector of a first participant and a private vector of a second participant;
a preprocessing module M2, configured to preprocess the private vector of the first participant and the private vector of the second participant to obtain a first participant private matrix and a second participant private matrix;
a secure two-party matrix multiplication computing module M3, configured to perform secure two-party matrix multiplication computing on the first participant private matrix and the second participant private matrix on the basis of a secure two-party matrix multiplication computing protocol, to obtain a first participant private output matrix and a second participant private output matrix, where the secure two-party matrix multiplication computing protocol is a protocol designed based on secure data disguising technology; the secure data disguising technology is a technology that decomposes any multi-party operation into a new multi-party addition to disguise an intermediate computing result; a sum of the first participant private output matrix and the second participant private output matrix is a product result of the first participant private matrix and the second participant private matrix;
a dimensionality reduction conversion processing module M4, configured to perform dimensionality reduction conversion processing on the first participant private output matrix and the second participant private output matrix, to obtain a first dimensionality-reduced private vector and a second dimensionality-reduced private vector; and
an aggregation module M5, configured to aggregate the first dimensionality-reduced private vector and the second dimensionality-reduced private vector to obtain a secure two-party vector element-wise multiplication result.

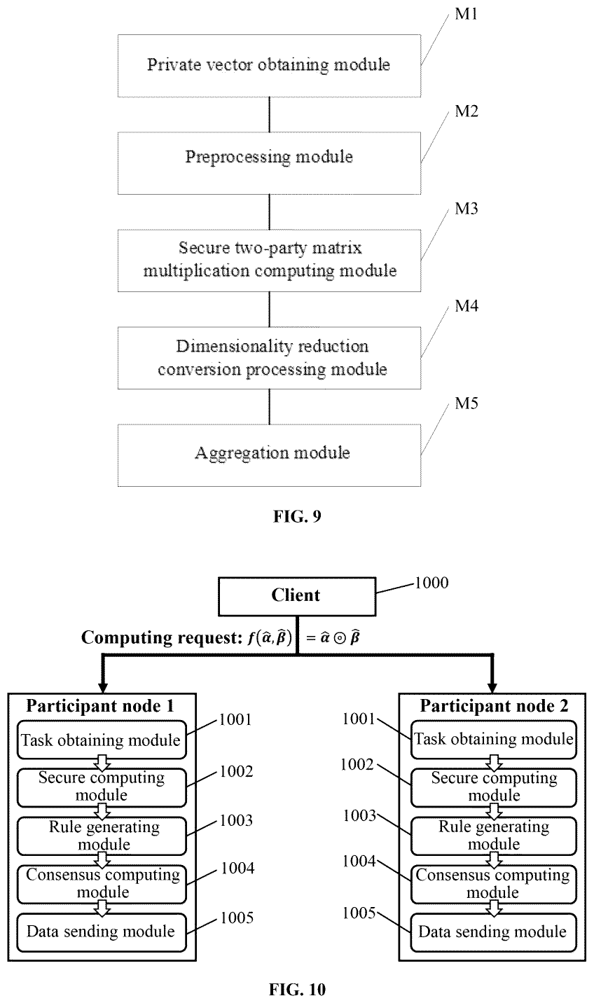

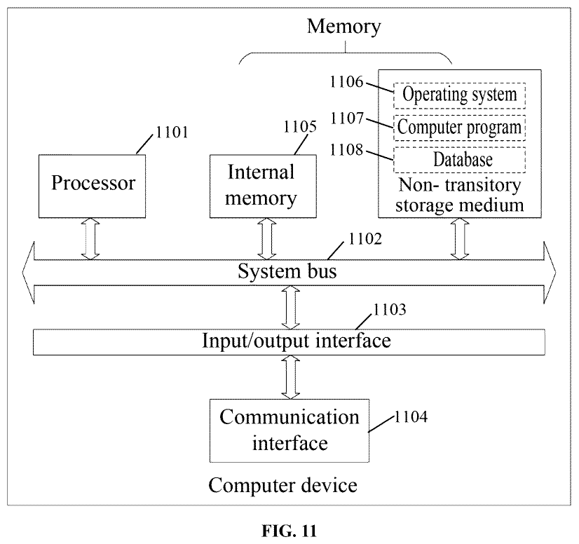

As an optional implementation, as shown in FIG. 10, an execution process thereof is as follows.

First, it is necessary to deploy a corresponding distributed computing framework on computing participant nodes participating in a two-party secure numerical multiplication task. The framework consists of five modules, specifically including: a task obtaining module 1001, a secure computing module 1002, a rule generating module 1003, a consensus computing module 1004, and a data sending module 1005. The task obtaining module 1001 is responsible for receiving and decoding a privacy-preserving computing request from a client 1000. The secure computing module 1002 automatically matches a corresponding secure computing protocol according to the computing request after decoded. The rule generating module 1003 decomposes a computing task according to an asynchronous instruction set of the secure computing protocol, and different computing nodes perform collaborative computing according to respective corresponding sub-rules. After receiving the assigned sub-rule, the consensus computing module 1004 uses a consensus protocol to ensure the synchronization of computing and consistency of results. After the computing is completed, the data sending module 1005 collects computing results of the participant nodes and transmits the computing results to the computing requester.

In an exemplary embodiment, by using an HTTP or GRPC communication protocol, an external client sends a two-party vector element-wise multiplication computing request to a network terminal where a distributed computing service is deployed. When a task obtaining module 1001 of a node on the network receives the computing request for vector element-wise multiplication, the task obtaining module 1001 parses the request and starts a secure computing service process of corresponding computing participant node 1 and node 2. When the task obtaining module 1001 has completed parsing a corresponding computing requirement, the corresponding computing requirement will be passed to the secure computing module 1002, and the secure computing module 1002 will conduct a joint query through an internal interface thereof; after matching a corresponding secure computing protocol, the secure computing module 1002 synchronizes the secure computing protocol to the rule generating modules 1003 in the two participant nodes. The rule generating module 1003 will formulate different asynchronous parallel execution processes according to different subtasks undertaken by the two different participant nodes, and maintain communication with the consensus computing module 1004 at every step of the execution. The consensus computing module 1004 broadcasts and maintains the consistency of results of distributed computing nodes on the chain and the stability of a control execution process while the two participant nodes execute instructions for each step of computing. After execution of the computing protocol is finally completed, the two participant nodes obtain sub-results computed by each other, and then send disguised and decomposed sub-vectors of the two participants to the computing requester via the data sending module 1005 to obtain a correct computing result.

Compared with the prior art, the present disclosure has the following advantages:
1) The present disclosure proposes a secure two-party matrix multiplication computing protocol S2PM based on secure data disguising technology in a semi-honest scenario. Compared with existing homomorphic encryption, secret sharing, and garbled circuit schemes, this protocol reduces the computational complexity to a O(n³) level. Furthermore, the constant number of rounds of interactions and the intermediate transfer data being all real numbers ensure that communication overheads and costs are controlled in a low range, taking into account the requirement balance of an impossible trinity of security, lightness, and efficiency.
2) The present disclosure proposes a secure two-party vector element-wise multiplication protocol S2PVEM, in which two participant nodes jointly negotiate a n, and vector element-wise multiplication is converted into matrix multiplication through scaling and spatial dimensionality reduction, so as to utilize the secure two-party matrix multiplication protocol S2PM to implement parallel computing with high computing efficiency, fewer communication rounds, and no need to introduce any secret key encryption operations. Furthermore, due to the characteristic of the secure two-party vector element-wise multiplication protocol S2PVEM of being based on real number domain operations, the present disclosure is not limited to integer computing tasks and can effectively avoid precision problems caused by technology such as garbled circuits and homomorphic encryption in the processing of floating-point numbers.
3) The present disclosure performs expansion based on the idea of the secure two-party vector element-wise multiplication protocol S2PVEM, and proposes a secure multi-party vector element-wise multiplication protocol SNPVEM, in which for N participant nodes, a final answer can be obtained by calling a total of

$$\frac{N \times ( N - 1 )}{2}$$

rounds of the secure two-party vector element-wise multiplication protocol S2PVEM. The process is based on real number field operations, and can ensure high computing accuracy, exhibit scalability, and avoid the need to build a huge circuit network in expansion based on garbled circuit technology and the generation of a large amount of information exchange in expansion based on secret sharing technology.
4) The secure two-party vector element-wise multiplication protocol S2PVEM and the secure multi-party vector element-wise multiplication protocol SNPVEM proposed by the present disclosure have more guarantees in terms of security. Because the two protocols do not rely on third-party cloud platforms, the risk of privacy data leakage due to attacks on the third-party cloud platforms can be avoided.

In an exemplary embodiment, a computer device is provided. The computer device may be a server or a terminal, and a diagram of an internal structure thereof may be as shown in FIG. 11. The computer device includes a processor 1101, a memory, an input/output interface 1103 (I/O for short), and a communication interface 1104. The processor 1101, the memory, and the input/output interface 1103 are connected via a system bus 1102, and the communication interface 1104 is connected to the system bus 1102 via the input/output interface 1103. The processor 1101 of the computer device is used to provide computing and control capabilities. The memory of the computer device includes a non-volatile storage medium and an internal memory 1105. The non-volatile storage medium stores an operating system 1106, a computer program 1107, and a database 1108. The internal memory 1105 provides an environment for the operation of the operating system 1106 and computer programs 1107 in the non-volatile storage medium. The database 1108 of the computer device is used to store a private vector of a first participant and a private vector of a second participant. The input/output interface 1103 of the computer device is used to exchange information between the processor 1101 and external devices. The communication interface 1104 of the computer device is used to communicate with an external terminal via a network connection. When the computer program 1107 is executed by the processor 1101, a spatial dimensionality reduction-based secure two-party vector element-wise multiplication method is implemented, as illustrated in FIGS. 1-10 and described in the corresponding specification.

Those skilled in the art will understand that the structure shown in FIG. 11 is merely a block diagram of a partial structure related to the solution of the present disclosure, and does not constitute a limitation on the computer device to which the solution of the present disclosure is applied. The specific computer device may include more or fewer components than those shown in the figure, or combine certain components, or have a different arrangement of components.

In an exemplary embodiment, a computer device is further provided, including a memory and a processor. A computer program is stored in the memory, and the above method and system embodiments are implemented when the processor executes the computer program, as illustrated in FIGS. 1-10 and described in the corresponding specification.

In an exemplary embodiment, a computer-readable storage medium, storing a computer program is provided. When the computer program is executed by a processor, the above method and system embodiments are implemented, as illustrated in FIGS. 1-10 and described in the corresponding specification.

In an exemplary embodiment, a computer program product is provided, including a computer program, and when the computer program is executed by a processor, the above method and system embodiments are implemented, as illustrated in FIGS. 1-10 and described in the corresponding specification.

It should be noted that the user information (including, but not limited to, user device information, user personal information, etc.) and data (including, but not limited to, data for analysis, stored data, displayed data, etc.) involved in the present disclosure are all information and data authorized by the user or fully authorized by all participants, and the collection, use, and processing of relevant data need to comply with relevant regulations.

A person of ordinary skill in the art may understand that all or part of the processes in the above embodiment methods may be implemented by instructing related hardware through a computer program. The computer program may be stored in a non-volatile computer-readable storage medium. When the computer program is executed, the processes of the embodiments of the above methods may be included. Any reference to a memory, a database, or other medium used in the embodiments provided by the present disclosure may include at least one of a non-volatile memory and a volatile memory. The non-volatile memory may include a read-only memory (ROM), a magnetic tape, a floppy disk, a flash memory, an optical storage, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory, etc. By way of illustration and not limitation, the RAM may be in various forms, such as a static random access memory (SRAM) or a dynamic random access memory (DRAM).

The database involved in the embodiments provided by the present disclosure may include at least one of a relational database and a non-relational database. The non-relational database may include, but is not limited to, distributed databases based on blockchain. The processor involved in the embodiments provided by the present disclosure may be a general-purpose processor, a central processing unit, a graphics processor, a digital signal processor, a programmable logic unit, a quantum computing-based data processing logic unit, etc., but is not limited thereto.

The technical features of the above embodiments may be arbitrarily combined. To make the description concise, not all possible combinations of the technical features in the above embodiments are described. However, the combinations should be considered to be within the scope of the description provided there is no contradiction in the combinations of those technical features.

In the present disclosure, the principle and embodiments of the present disclosure are described herein by using specific examples, the above descriptions of the embodiments are merely intended to help understand the methods and core idea of the present disclosure. In addition, for those of ordinary skill in the art, changes may be made to the specific embodiments and the scope of application according to the concept of the present disclosure. In summary, the content of the description should not be construed as a limitation to the present disclosure.

What is claimed is:

1. A spatial dimensionality reduction-based secure two-party vector element-wise multiplication method, comprising:
obtaining a private vector of a first participant and a private vector of a second participant;
preprocessing the private vector of the first participant and the private vector of the second participant to obtain a first participant private matrix and a second participant private matrix;
performing secure two-party matrix multiplication computing on the first participant private matrix and the second participant private matrix on a basis of a secure two-party matrix multiplication computing protocol, to obtain a first participant private output matrix and a second participant private output matrix, wherein the secure two-party matrix multiplication computing protocol is a protocol designed based on secure data disguising technology; the secure data disguising technology is a technology that decomposes any multi-party operation into a multi-party addition to disguise an intermediate computing result; a sum of the first participant private output matrix and the second participant private output matrix is a product result of the first participant private matrix and the second participant private matrix;
performing dimensionality reduction conversion processing on the first participant private output matrix and the second participant private output matrix, respectively, to obtain a first dimensionality-reduced private vector and a second dimensionality-reduced private vector; and
aggregating the first dimensionality-reduced private vector and the second dimensionality-reduced private vector to obtain a secure two-party vector element-wise multiplication result.

2. The spatial dimensionality reduction-based secure two-party vector element-wise multiplication method according to claim 1, wherein the preprocessing the private vector of the first participant and the private vector of the second participant to obtain a first participant private matrix and a second participant private matrix comprises:
determining a decomposition positive integer, wherein the decomposition positive integer is greater than or equal to 2;
decomposing each element of the private vector of the first participant according to the decomposition positive integer to obtain several first decomposed private vectors;
decomposing each element of the private vector of the second participant according to the decomposition positive integer to obtain several second decomposed private vectors;
transforming and sorting the several first decomposed private vectors to obtain the first participant private matrix; and
transforming and sorting the several second decomposed private vectors to obtain the second participant private matrix.

3. The spatial dimensionality reduction-based secure two-party vector element-wise multiplication method according to claim 1, wherein the performing secure two-party matrix multiplication computing on the first participant private matrix and the second participant private matrix on a basis of a secure two-party matrix multiplication computing protocol, to obtain a first participant private output matrix and a second participant private output matrix comprises:
generating two random matrix pairs on a basis of an auxiliary computing node, wherein the two random matrix pairs comprise: a random matrix pair (Rₐ,rₐ) and a random matrix pair (R_{b},r_{b}), wherein the dimensionality of the random matrix Rₐ is n×s, the dimensionality of the random matrix R_{b} is s×m, and the dimensionalities of the random matrix rₐ and the random matrix r_{b} are n×m; rₐ+r_{b}=Rₐ·R_{b};
sending the random matrix pair (Rₐ,rₐ) to the first participant;
sending the random matrix pair (R_{b},r_{b}) to the second participant;
computing, by the first participant, a sum of the first participant private matrix and the random matrix Rₐ after receiving the random matrix pair (Rₐ,rₐ), to obtain a first matrix sum, and sending the first matrix sum to the second participant;
computing, by the second participant, a sum of the second participant private matrix and the random matrix R_{b} after receiving the random matrix pair (R_{b},r_{b}), to obtain a second matrix sum, and sending the second matrix sum to the first participant;
generating, by the second participant, a second participant private output matrix after receiving the first matrix sum;
computing a disguising matrix according to the second participant private output matrix; and sending the disguising matrix to the first participant, wherein a computing formula for the disguising matrix is: T=Â·B+(r_{b}−V_{b}), wherein T is the disguising matrix, Â is the first matrix sum, B is the second participant private matrix, and V_{b} is the second participant private output matrix, which is a random matrix secretly generated internally; and
computing, by the first participant, a first participant private output matrix after receiving the disguising matrix, wherein a computing formula for the first participant private output matrix is: Vₐ=T+rₐ−(Rₐ·\hat{B}), wherein Vₐ is the first participant private output matrix, and \hat{B} is the second matrix sum.

4. The spatial dimensionality reduction-based secure two-party vector element-wise multiplication method according to claim 1, wherein the performing dimensionality reduction conversion processing on the first participant private output matrix and the second participant private output matrix respectively, to obtain a first dimensionality-reduced private vector and a second dimensionality-reduced private vector comprises:
extracting and vectorizing several elements on a main diagonal of the first participant private output matrix to obtain the first dimensionality-reduced private vector; and
extracting and vectorizing several elements on a main diagonal of the second participant private output matrix to obtain the second dimensionality-reduced private vector.

5. The spatial dimensionality reduction-based secure two-party vector element-wise multiplication method according to claim 4, wherein a computing formula for the first dimensionality-reduced private vector is:
$${W}_{a} = m 2 v ( diag ( {V}_{a} ) ) ;$$
a computing formula for the second dimensionality-reduced private vector is:
$${W}_{b} = m 2 v ( diag ( {V}_{b} ) ) ,$$
wherein Wₐ is the first dimensionality-reduced private vector, W_{b} is the second dimensionality-reduced private vector, m2v is a function to convert an element of a diagonal matrix into a corresponding vector in an element-wise manner, and diag is a function to extract a diagonal element of an arbitrary matrix to form the diagonal matrix.

6. The spatial dimensionality reduction-based secure two-party vector element-wise multiplication method according to claim 1, wherein a computing formula for aggregating the first dimensionality-reduced private vector and the second dimensionality-reduced private vector to obtain the secure two-party vector element-wise multiplication result is:
$${f}_{S 2 PVEM} ( α , β ) = α β = {W}_{a} + {W}_{b} ,$$
wherein ƒ_{S2PVEM}(⋅) is a secure two-party vector element-wise multiplication protocol, α is n-dimensional private vector of the first participant, β is n-dimensional private vector of the second participant, Wₐ is the first dimensionality-reduced private vector, W_{b} is the second dimensionality-reduced private vector, and ⊚ is secure two-party vector element-wise multiplication.

7. A spatial dimensionality reduction-based secure two-party vector element-wise multiplication apparatus, comprises:
a private vector obtaining module, configured to obtain a private vector of a first participant and a private vector of a second participant;
a preprocessing module, configured to preprocess the private vector of the first participant and the private vector of the second participant to obtain a first participant private matrix and a second participant private matrix;
a secure two-party matrix multiplication computing module, configured to perform secure two-party matrix multiplication computing on the first participant private matrix and the second participant private matrix on a basis of a secure two-party matrix multiplication computing protocol, to obtain a first participant private output matrix and a second participant private output matrix, wherein the secure two-party matrix multiplication computing protocol is a protocol designed based on secure data disguising technology; the secure data disguising technology is a technology that decomposes any multi-party operation into a multi-party addition to disguise an intermediate computing result; a sum of the first participant private output matrix and the second participant private output matrix is a product result of the first participant private matrix and the second participant private matrix;
a dimensionality reduction conversion processing module, configured to perform dimensionality reduction conversion processing on the first participant private output matrix and the second participant private output matrix respectively, to obtain a first dimensionality-reduced private vector and a second dimensionality-reduced private vector; and
an aggregation module, configured to aggregate the first dimensionality-reduced private vector and the second dimensionality-reduced private vector to obtain a secure two-party vector element-wise multiplication result.

8. A computer device, comprising: a memory, a processor, and a computer program stored in the memory and executable on the processor, wherein the processor executes the computer program to implement the spatial dimensionality reduction-based secure two-party vector element-wise multiplication method according to claim 1.

9. The computer device according to claim 8, wherein the preprocessing the private vector of the first participant and the private vector of the second participant to obtain a first participant private matrix and a second participant private matrix comprises:
determining a decomposition positive integer, wherein the decomposition positive integer is greater than or equal to 2;
decomposing each element of the private vector of the first participant according to the decomposition positive integer to obtain several first decomposed private vectors;
decomposing each element of the private vector of the second participant according to the decomposition positive integer to obtain several second decomposed private vectors;
transforming and sorting the several first decomposed private vectors to obtain the first participant private matrix; and
transforming and sorting the several second decomposed private vectors to obtain the second participant private matrix.

10. The computer device according to claim 8, wherein the performing secure two-party matrix multiplication computing on the first participant private matrix and the second participant private matrix on a basis of a secure two-party matrix multiplication computing protocol, to obtain a first participant private output matrix and a second participant private output matrix comprises:
generating two random matrix pairs on a basis of an auxiliary computing node, wherein the two random matrix pairs comprise: a random matrix pair (Rₐ,rₐ) and a random matrix pair (R_{b},r_{b}), wherein the dimensionality of the random matrix Rₐ is n×s, the dimensionality of the random matrix R_{b} is s×m, and the dimensionalities of the random matrix rₐ and the random matrix r_{b} are n×m; rₐ+r_{b}=Rₐ·R_{b};
sending the random matrix pair (Rₐ,rₐ) to the first participant;
sending the random matrix pair (R_{b}, r_{b}) to the second participant;
computing, by the first participant, a sum of the first participant private matrix and the random matrix Rₐ after receiving the random matrix pair (Rₐ,rₐ), to obtain a first matrix sum, and sending the first matrix sum to the second participant;
computing, by the second participant, a sum of the second participant private matrix and the random matrix R_{b} after receiving the random matrix pair (R_{b},r_{b}), to obtain a second matrix sum, and sending the second matrix sum to the first participant;
generating, by the second participant, a second participant private output matrix after receiving the first matrix sum;
computing a disguising matrix according to the second participant private output matrix; and sending the disguising matrix to the first participant, wherein a computing formula for the disguising matrix is: T=Â·B+(r_{b}−V_{b}), wherein T is the disguising matrix, Â is the first matrix sum, B is the second participant private matrix, and V_{b} is the second participant private output matrix, which is a random matrix secretly generated internally; and
computing, by the first participant, a first participant private output matrix after receiving the disguising matrix, wherein a computing formula for the first participant private output matrix is: Vₐ=T+rₐ−(Rₐ·\hat{B}), wherein Vₐ is the first participant private output matrix, and \hat{B} is the second matrix sum.

11. The computer device according to claim 8, wherein the performing dimensionality reduction conversion processing on the first participant private output matrix and the second participant private output matrix respectively, to obtain a first dimensionality-reduced private vector and a second dimensionality-reduced private vector comprises:
extracting and vectorizing several elements on a main diagonal of the first participant private output matrix to obtain the first dimensionality-reduced private vector; and
extracting and vectorizing several elements on a main diagonal of the second participant private output matrix to obtain the second dimensionality-reduced private vector.

12. The computer device according to claim 11, wherein a computing formula for the first dimensionality-reduced private vector is:
$${W}_{a} = m 2 v ( diag ( {V}_{a} ) ) ;$$
a computing formula for the second dimensionality-reduced private vector is:
$${W}_{b} = m 2 v ( diag ( {V}_{b} ) ) ,$$
wherein Wₐ is the first dimensionality-reduced private vector, W_{b} is the second dimensionality-reduced private vector, m2v is a function to convert an element of a diagonal matrix into a corresponding vector in an element-wise manner, and diag is a function to extract a diagonal element of an arbitrary matrix to form the diagonal matrix.

13. The computer device according to claim 8, wherein a computing formula for aggregating the first dimensionality-reduced private vector and the second dimensionality-reduced private vector to obtain the secure two-party vector element-wise multiplication result is:
$${f}_{S 2 PVEM} ( α , β ) = α β = {W}_{a} + {W}_{b} ,$$
wherein ƒ_{S2PVEM}(⋅) is a secure two-party vector element-wise multiplication protocol, α is n-dimensional private vector of the first participant, β is n-dimensional private vector of the second participant, Wₐ is the first dimensionality-reduced private vector, W_{b} is the second dimensionality-reduced private vector, and ⊚ is secure two-party vector element-wise multiplication.

14. A non-transitory computer-readable storage medium having a computer program stored thereon, wherein when the computer program is executed by a processor, the spatial dimensionality reduction-based secure two-party vector element-wise multiplication method according to claim 1 is implemented.

15. The non-transitory computer-readable storage medium according to claim 14, wherein the preprocessing the private vector of the first participant and the private vector of the second participant to obtain a first participant private matrix and a second participant private matrix comprises:
determining a decomposition positive integer, wherein the decomposition positive integer is greater than or equal to 2;
decomposing each element of the private vector of the first participant according to the decomposition positive integer to obtain several first decomposed private vectors;
decomposing each element of the private vector of the second participant according to the decomposition positive integer to obtain several second decomposed private vectors;
transforming and sorting the several first decomposed private vectors to obtain the first participant private matrix; and
transforming and sorting the several second decomposed private vectors to obtain the second participant private matrix.

16. The non-transitory computer-readable storage medium according to claim 14, wherein the performing secure two-party matrix multiplication computing on the first participant private matrix and the second participant private matrix on a basis of a secure two-party matrix multiplication computing protocol, to obtain a first participant private output matrix and a second participant private output matrix comprises:
generating two random matrix pairs on a basis of an auxiliary computing node, wherein the two random matrix pairs comprise: a random matrix pair (Rₐ,rₐ) and a random matrix pair (R_{b},r_{b}), wherein the dimensionality of the random matrix Rₐ is n×s, the dimensionality of the random matrix R_{b} is s×m, and the dimensionalities of the random matrix rₐ and the random matrix r_{b} are n×m; rₐ+r_{b}=Rₐ·R_{b};
sending the random matrix pair (Rₐ,rₐ) to the first participant;
sending the random matrix pair (R_{b},r_{b}) to the second participant;
computing, by the first participant, a sum of the first participant private matrix and the random matrix Rₐ after receiving the random matrix pair (Rₐ,rₐ), to obtain a first matrix sum, and sending the first matrix sum to the second participant;
computing, by the second participant, a sum of the second participant private matrix and the random matrix R_{b} after receiving the random matrix pair (R_{b},r_{b}), to obtain a second matrix sum, and sending the second matrix sum to the first participant;
generating, by the second participant, a second participant private output matrix after receiving the first matrix sum;
computing a disguising matrix according to the second participant private output matrix; and sending the disguising matrix to the first participant, wherein a computing formula for the disguising matrix is: T=Â·B+(r_{b}−V_{b}), wherein T is the disguising matrix, Â is the first matrix sum, B is the second participant private matrix, and V_{b} is the second participant private output matrix, which is a random matrix secretly generated internally; and
computing, by the first participant, a first participant private output matrix after receiving the disguising matrix, wherein a computing formula for the first participant private output matrix is: Vₐ=T+rₐ−(Rₐ·\hat{B}), wherein Vₐ is the first participant private output matrix, and \hat{B} is the second matrix sum.

17. The non-transitory computer-readable storage medium according to claim 14, wherein the performing dimensionality reduction conversion processing on the first participant private output matrix and the second participant private output matrix respectively, to obtain a first dimensionality-reduced private vector and a second dimensionality-reduced private vector comprises:
extracting and vectorizing several elements on a main diagonal of the first participant private output matrix to obtain the first dimensionality-reduced private vector; and
extracting and vectorizing several elements on a main diagonal of the second participant private output matrix to obtain the second dimensionality-reduced private vector.

18. The non-transitory computer-readable storage medium according to claim 17, wherein a computing formula for the first dimensionality-reduced private vector is:
$${W}_{a} = m 2 v ( diag ( {V}_{a} ) ) ;$$
a computing formula for the second dimensionality-reduced private vector is:
$${W}_{b} = m 2 v ( diag ( {V}_{b} ) ) ,$$
wherein Wₐ is the first dimensionality-reduced private vector, W_{b} is the second dimensionality-reduced private vector, m2v is a function to convert an element of a diagonal matrix into a corresponding vector in an element-wise manner, and diag is a function to extract a diagonal element of an arbitrary matrix to form the diagonal matrix.

19. The non-transitory computer-readable storage medium according to claim 14, wherein a computing formula for aggregating the first dimensionality-reduced private vector and the second dimensionality-reduced private vector to obtain the secure two-party vector element-wise multiplication result is:
$${f}_{S 2 PVEM} ( α , β ) = α β = {W}_{a} + {W}_{b} ,$$
wherein ƒ_{S2PVEM}(⋅) is a secure two-party vector element-wise multiplication protocol, α is n-dimensional private vector of the first participant, β is n-dimensional private vector of the second participant, Wₐ is the first dimensionality-reduced private vector, W_{b} is the second dimensionality-reduced private vector, and ⊚ is secure two-party vector element-wise multiplication.
